(19) United States
(12) Patent Application Publication
(10) Pub. No.: US 2010/0087264 A1
(43) Pub. Date: Apr. 8, 2010

(54) BOWLING PIN AND MANUFACTURING METHOD THEREOF

(75) Inventors: Nobufumi Suzuki, Shizuoka (JP); Takae Mouri, Shizuoka (JP)

Correspondence Address: BROWDY AND NEIMARK, P.L.L.C.;624 NINTH STREET, NW, SUITE 300, WASHINGTON, DC, 20001-5303, US

(73) Assignee: HAMAMATSU KENNA CO., LTD., HAMAMATSU-SHI (JP)

(21) Appl. No.: 11/816,606

(22) PCT Filed: May 8, 2007
(86) PCT No.: PCT/JP2007/059535

§ 371 Date: Dec. 8, 2009

(30) Foreign Application Priority Data
May 9, 2006 (JP) 2006-130816
Nov. 21, 2006 (JP) 2006-314899

(51) Int. Cl. A63D 9/00; B29C 45/16

(52) U.S. Cl. 473/119; 264/250

(57) ABSTRACT

To provide a bowling pin which exhibits a pin action of the bowling pin which is generated due to strong hitting of the ball with the bowling pin close to a pin action of a conventional bowling pin. An upper core 25 and a lower core 23 are set in a core material forming mold 21, a molten synthetic resin is injected into a cavity 27 through a gate 26 and is cooled and, thereafter, the upper and lower cores are removed thus forming by molding the core material 3 which includes an upper hollow portion 5a having an upper opening, a lower hollow portion 5b having a lower opening and a circumferential groove 4a which surrounds a largest diameter portion of the core material and, thereafter, a resilient strip 4 is formed by filling a synthetic resin softer than a synthetic resin for forming the core material into the circumferential groove, an upper cap is mounted on the upper hollow portion and a lower cap is mounted on the lower hollow portion, a projecting portion of the upper cap is inserted into a recessed portion of an upper mold thus forming an upper engaging portion, a pin of a lower mold is inserted into a recessed portion of the lower cap thus forming a lower engaging portion, the core material is vertically fixed to the inside of the cavity while maintaining a gap around the core material, and a molten resin is injected into the gap through a gate thus covering the upper and lower caps, the resilient strip and the core material with the skin portion.

### TECHNICAL FIELD

The present invention relates to a bowling pin and a manufacturing method thereof, and more particularly to a bowling pin which exhibits the excellent durability without breaking and a repulsive force when a strong impact is applied to the pin from a ball and a manufacturing method thereof.

### BACKGROUND ART

People generally enjoy bowling not only as an easily accessible leisure but also as a sport. With respect to a pin which is served for bowling, a pin action when a ball hits the pin or other pin hits the pin is important. That is, provided that conditions such as an impact force, an impact angle and the like at the time of hitting are equal among pins, a uniform pin action is required. Accordingly, in conformity with the international standard, the shape, the weight of the bowling pin and the like are strictly determined.

Further, the bowling pin is also required to generate a dry sound peculiar to the pin which is generated when the ball hits the pin or the pins hit each other and to have durability which can withstand the repeating hitting. Conventionally, a bowling pin which covers a surface of a wooden core material with a synthetic resin layer has been used. Further, on a surface of this wooden ball or pin, a display portion constituted of letters, patterns and the like is formed by coating by baking. In patent document 1, for example, there is disclosed a bowling pin in which a circumferential groove having a proper width and a proper depth is arranged in a periphery of a largest diameter portion of a wooden bowling pin body, a synthetic-resin-made strip is fitted into the circumferential groove, a longitudinally elongated hollow space is formed at a center of the minimum diameter portion, a core rod made of a synthetic resin is fitted in the hollow space and an outer surface of the bowling pin body is covered with an outer coating made of a synthetic resin. However, the bowling pin body of the bowling pin disclosed in patent document 1 is made of wood and hence, the bowling pin has several drawbacks. For example, when the heavy ball hits the pin, a speed attributed to throwing of the ball is added to the ball and hence, the energy of the ball at the time of hitting the ball is extremely large. Accordingly, although a use period of the pin may depend on the frequency of use of the pin, the pin must be exchanged with a new pin at an interval of approximately several months thus giving rise to a drawback that the use period of the pin is relatively short.

Accordingly, in recent years, there has been proposed a bowling pin body made of a synthetic resin which exhibits high durability in place of the wooden core material. In patent document 2, for example, there has been proposed a so-called bowling pin made of a two-layered resin in which a core material is formed by molding a molten resin into a cavity of a first mold and by solidifying the molten resin and a skin is formed on a periphery of the core material by molding.

[Patent document 1] JP-UM-A-6-77781
[Patent document 2] JP-A-2002-205316

### DISCLOSURE OF THE INVENTION

### Problems That the Invention is to Solve

However, the bowling pin disclosed in patent document 2 has following drawbacks. That is, in forming the skin, holes are formed in upper and lower portions of the core material for fixing the core material to the mold, and a resin-made cap is press-fitted into the holes in a final step of the manufacture of the bowling pin. However, the hard resin-made core material is covered with the resin-made skin which is harder than the core material and hence, a pin action of the bowling pin which is generated due to strong hitting of the ball with the bowling pin becomes too strong thus giving rise to a drawback that the pin action differs from a pin action of a wooden bowling pin which is conventionally used. Further, there also arises a drawback that the bowling pin breaks at a neck portion thereof due to a strong action attributed to hitting of the ball with the bowling pin or hitting of the balls each other.

The present invention has been made in view of the above-mentioned drawbacks and it is an object of the present invention to provide a bowling pin which exhibits a pin action close to a pin action of a conventional bowling pin while satisfying conditions such as a shape and a weight which the bowling pin is required to satisfy, a sound which is generated at the time of hitting and the like, and a manufacturing method thereof. It is also an object of the present invention to provide a bowling pin of high durability which is not broken at a neck portion thereof even when a strong impact is applied to the bowling pin due to hitting of a ball with the bowling pin or hitting of the bowling pins each other and the manufacturing method thereof.

### Means for Solving the Problem

A manufacturing method of a bowling pin according to the present invention is characterized in that the manufacturing method of a bowling pin includes: a core material manufacturing step for forming a core material having a shape smaller than a profile of the bowling pin by molding; and a skin portion forming step for covering an outer surface of the core material, wherein an upper core, a lower core and a reinforcing core which is sandwiched between the upper core and the lower core are set in a core material forming mold, a synthetic resin in a molten state is injected into a cavity through a gate and is cooled and, thereafter, the upper core and the lower core are removed thus forming by molding the core material which includes an upper hollow portion having an upper opening which opens upwardly and a lower hollow portion having a lower opening which opens downwardly, and molds the reinforcing core therein, an upper cap is mounted on the upper hollow portion and a lower cap is mounted on the lower hollow portion, a projecting portion of the upper cap is inserted into a recessed portion of an upper mold thus forming an upper engaging portion, a pin of a lower mold is inserted into a recessed portion of the lower cap thus forming a lower engaging portion, the core material is vertically fixed to the inside of the cavity while maintaining a gap around the core material, and a molten resin is injected into the gap through a gate thus forming the skin portion and integrally covering the upper cap, the lower cap and the core material with the skin portion.

A bowling pin according to the present invention is characterized in that the bowling pin includes: a core material having a shape smaller than a profile of the bowling pin; and a skin portion covering an outer surface of the core material, wherein the core material is formed of an upper hollow portion having an upper opening which opens upwardly, a lower hollow portion having a lower opening which opens downwardly, and a reinforcing core which is formed by molding between the upper hollow portion and the lower hollow portion, an upper cap is mounted on the upper hollow portion and a lower cap is mounted on the lower hollow portion, and the upper cap, the lower cap and the core material are integrally formed in a state that the upper cap, the lower cap and the core material are covered with the skin portion.

In such a bowling pin, it is preferable that the lower cap is formed and covered with the skin portion in a state that a bottom surface of the lower cap is exposed to a surface of the bowling pin.

A manufacturing method of a bowling pin according to the present invention is characterized in that the manufacturing method of the bowling pin includes: a core material manufacturing step for forming a core material having a shape smaller than a profile of the bowling pin by molding; and

a skin portion forming step for covering an outer surface of the core material, wherein an upper core and a lower core are set in a core material forming mold, a synthetic resin in a molten state is injected into a cavity through a gate and is cooled and, thereafter, the upper core and the lower core are removed thus forming by molding the core material which includes an upper hollow portion having an upper opening which opens upwardly, a lower hollow portion having a lower opening which opens downwardly and a circumferential groove which surrounds a largest diameter portion of the core material and, thereafter, a resilient strip is circumferentially formed by filling a synthetic resin softer than a synthetic resin for forming the core material into the circumferential groove, an upper cap is mounted on the upper hollow portion and a lower cap is mounted on the lower hollow portion, a projecting portion of the upper cap is inserted into a recessed portion of an upper mold thus forming an upper engaging portion, a pin of a lower mold is inserted into a recessed portion of the lower cap thus forming a lower engaging portion, the core material is vertically fixed to the inside of the cavity while maintaining a gap around the core material, and a molten resin is injected into the gap through a gate thus covering the upper cap, the lower cap, the resilient strip and the core material with the skin portion.

A manufacturing method of a bowling pin according to the present invention is characterized in that an upper core and a lower core are set in a core material forming mold, a synthetic resin in a molten state is injected into a cavity through a gate and is cooled and, thereafter, the upper core and the lower core are removed thus forming by molding the core material which includes an upper hollow portion having an upper opening which opens upwardly, a lower hollow portion having a lower opening which opens downwardly and a circumferential groove which surrounds a largest diameter portion of the core material and, thereafter, a resilient strip is circumferentially formed by filling a synthetic resin softer than a synthetic resin for forming the core material into the circumferential groove, an upper cap is mounted on the upper hollow portion and a projecting portion of the upper cap is fitted in a recessed portion of an upper mold thus forming an upper engaging portion, a pin of a lower mold is fitted in the lower hollow portion thus forming a lower engaging portion, the core material is vertically fixed to the inside of the cavity while maintaining a gap around the core material, and a molten resin is injected into the gap through a gate thus covering the upper cap, the resilient strip and the core material with the skin portion and, thereafter, a lower cap is mounted on the lower hollow portion.

A manufacturing method of a bowling pin according to the present invention is characterized in that an upper core, a lower core and a reinforcing core which is sandwiched between the upper core and the lower core are set in a core material forming mold, a synthetic resin in a molten state is injected into a cavity through a gate and is cooled and, thereafter, the upper core and the lower core are removed thus forming by molding the core material which includes an upper hollow portion having an upper opening which opens upwardly and a lower hollow portion having a lower opening which opens downwardly, molds the reinforcing core therein, and includes a circumferential groove which surrounds a largest diameter portion of the core material and, thereafter, a resilient strip is circumferentially formed by filling a synthetic resin softer than a synthetic resin for forming the core material into the circumferential groove,

an upper cap is mounted on the upper hollow portion and a lower cap is mounted on the lower hollow portion, a projecting portion of the upper cap is inserted into a recessed portion of an upper mold thus forming an upper engaging portion, a pin of a lower mold is inserted into a recessed portion of the lower cap thus forming a lower engaging portion, the core material is vertically fixed to the inside of the cavity while maintaining a gap around the core material, and a molten resin is injected into the gap through a gate thus covering the upper cap, the lower cap, the resilient strip and the core material with the skin portion.

A bowling pin according to the present invention is characterized in that the bowling pin includes: a core material having a shape smaller than a profile of the bowling pin; and a skin portion covering an outer surface of the core material, wherein the core material is formed of an upper hollow portion having an upper opening which opens upwardly, a lower hollow portion having a lower opening which opens downwardly, and a circumferential groove which surrounds a largest diameter portion of the core material, an upper cap is mounted on the upper hollow portion and a lower cap is mounted on the lower hollow portion, a resilient strip made of a synthetic resin softer than a synthetic resin for forming the core material into the circumferential groove is circumferentially formed, and the upper cap, the lower cap, the resilient strip and the core material are covered with the skin portion.

A bowling pin according to the present invention is characterized in that the core material is formed of an upper hollow portion having an upper opening which opens upwardly, a lower hollow portion having a lower opening which opens downwardly, and a circumferential groove which surrounds a largest diameter portion of the core material, an upper cap is mounted on the upper hollow portion and a lower cap is mounted on the lower hollow portion, a resilient strip made of a synthetic resin softer than a synthetic resin for forming the core material into the circumferential groove is circumferentially formed, and the upper cap, the resilient strip and the core material are covered with the skin portion.

In such a bowling pin, it is preferable that a reinforcing core is molded in the core material.

### Advantage of the Invention

According to the bowling pin of the present invention, with provision of the bowling pin which is manufactured by forming the circumferential groove in a portion of the core material which the ball hits, by forming the resilient strip which is formed by filling the soft synthetic resin in the circumferential groove, and by covering the resilient strip with the skin portion, the bowling pin can absorb and attenuate a strong impact force of the ball and can approximate a pin action thereof to a pin action of a wooden bowling pin which has been used conventionally. Further, by inserting the reinforcing core in a neck portion of the bowling pin, even when the pin action which is generated due to a strong impact of the ball applied to the bowling pin is large, it is possible to provide the bowling pin which exhibits the excellent durability without breaking.

Further, according to the bowling pin of the present invention, the hollow portions are formed on both upper and lower end of the core material and the reinforcing core is molded in the portion which connects the hollow portions. Accordingly, even when the bowling pin repeatedly receives the strong impact during a bowling game, there is no possibility that the bowling pin breaks. Further, the bowling pin of the present invention is manufactured in a molded state in which a compression force of the skin portion acts on a surface of the core material having the reinforcing core and hence, there is no possibility that the bowling pin breaks even when the bowling pin receives the strong impact of the ball.

### BEST MODE FOR CARRYING OUT THE INVENTION

### Embodiment 1

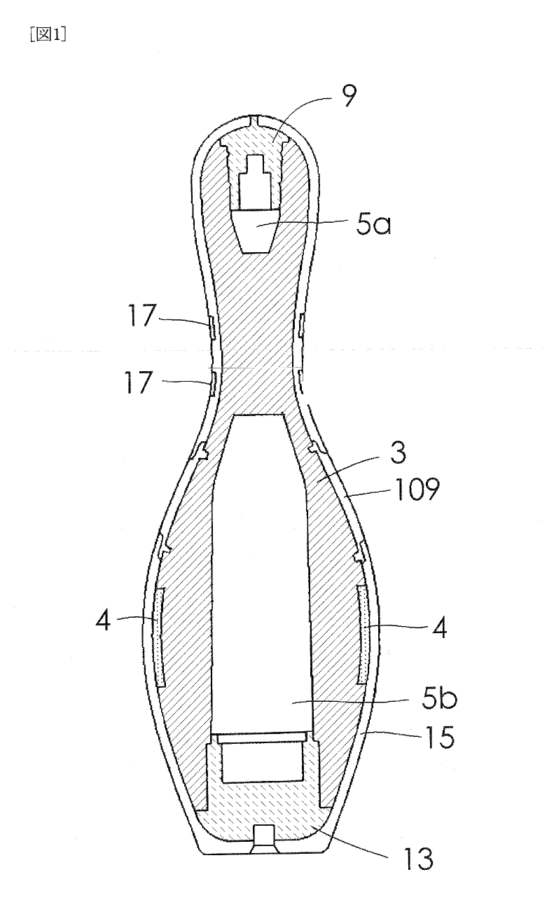

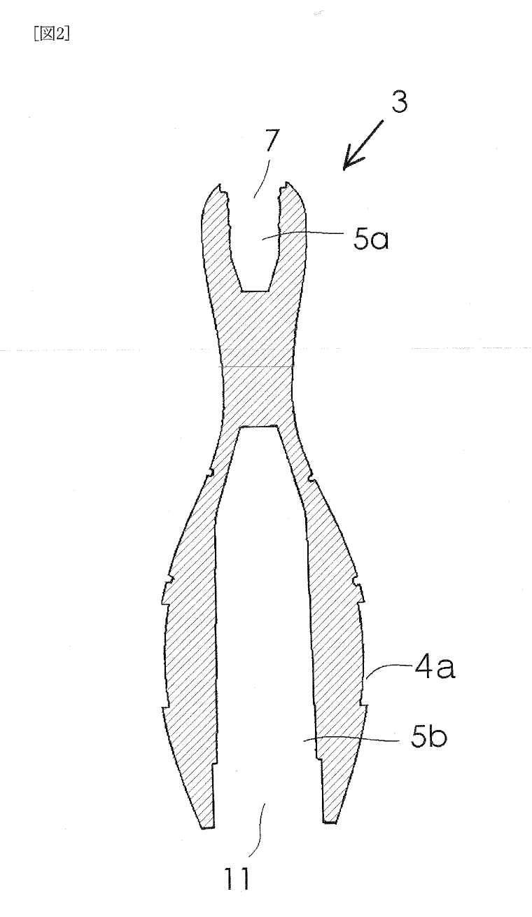

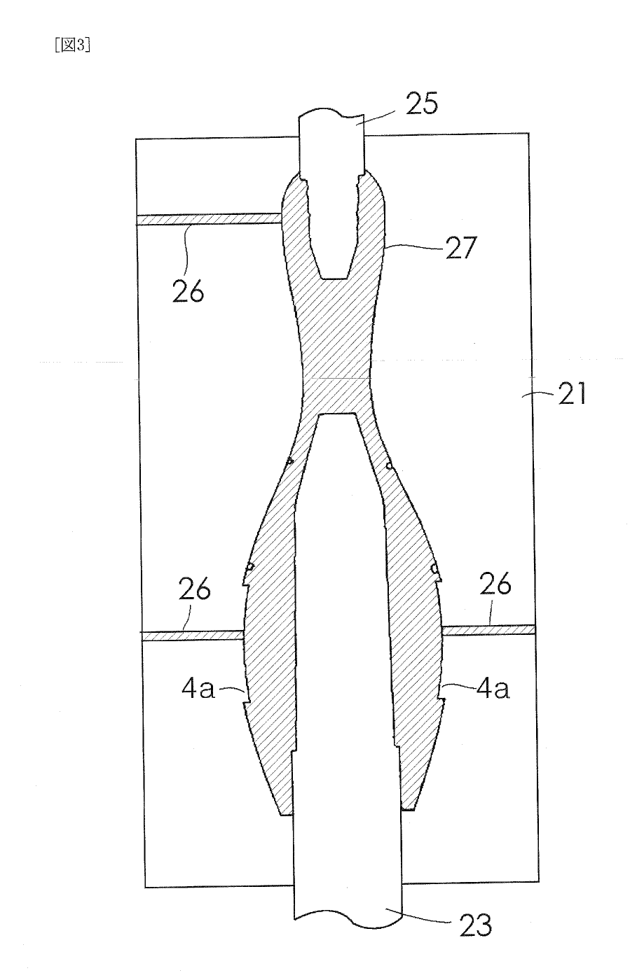

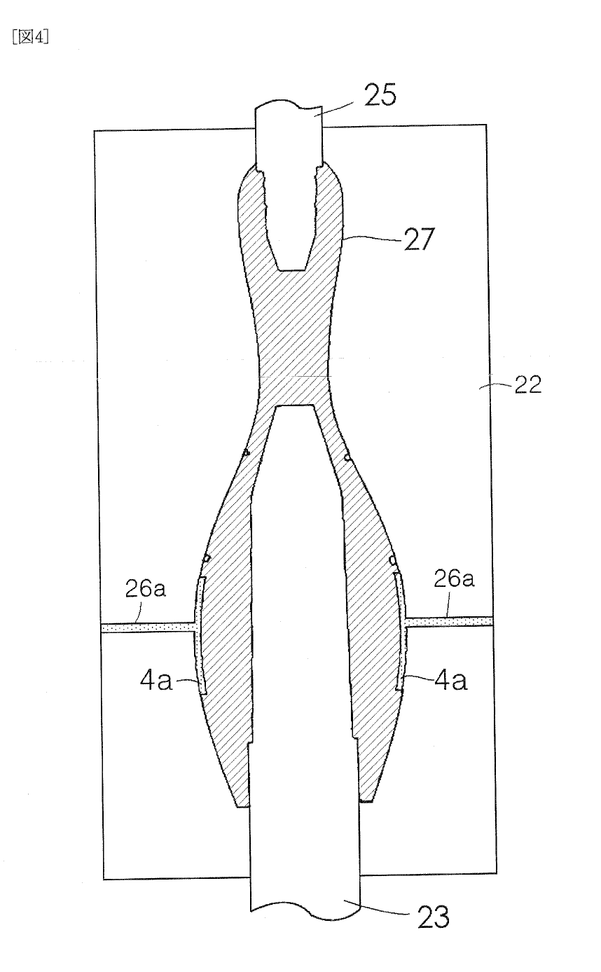

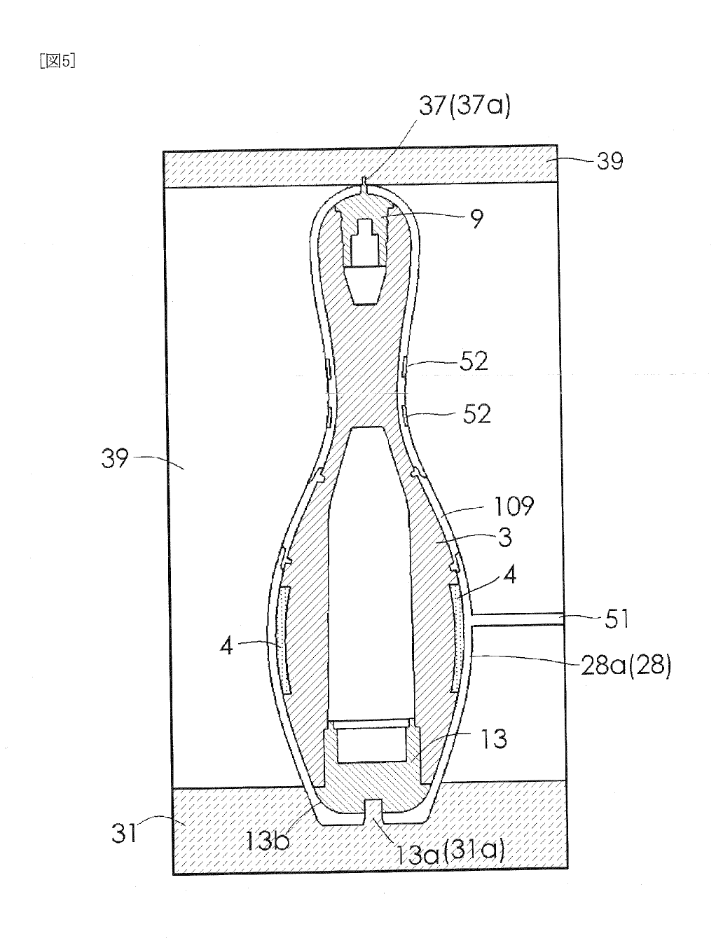

A bowling pin and a manufacturing method thereof according to an embodiment 1 of the present invention are explained in conjunction with drawings. FIG. 1 is a longitudinal cross-sectional view showing the constitution of a bowling pin of an embodiment 1. FIG. 2 is a longitudinal cross-sectional view showing the constitution of a core material which is molded in the inside of the bowling pin of the embodiment 1. FIG. 3 is a longitudinal cross-sectional view for explaining a manufacturing method of the core material. FIG. 4 is a longitudinal cross-sectional view for explaining a method for molding a resilient strip in a circumferential groove such that the resilient strip surrounds an outer periphery of a largest diameter portion of the core material. FIG. 5 is a longitudinal cross-sectional view for explaining a method for molding a skin portion on a surface of the core material. In FIG. 1 and FIG. 2, an upper portion of a core material 3 forms an upper hollow portion 5a and a lower portion of the core material 3 forms a lower hollow portion 5b. Although a core material is interposed between the upper hollow portion 5a and the lower hollow portion 5b, the upper hollow portion 5a and the lower hollow portion 5b may be communicated with each other. Further, a reinforcing core (described later in an embodiment 3) may be interposed between the upper hollow portion 5a and the lower hollow portion 5b. The upper hollow portion 5a has an upper opening 7 which opens at an upper end of the core material 3, while the lower hollow portion 5b has a lower opening 11 which opens at a lower end of the core material 3. Further, an upper cap 9 which constitutes a deformation prevention material is fitted into the upper opening 7 formed in the upper hollow portion 5a, while a lower cap 13 which constitutes a deformation prevention material is fitted into the lower opening 11 formed in the lower hollow portion 5b.

In these drawings, the core material 3, the upper cap 9 and the lower cap 13 are covered with a skin portion 15. Portions of the core material 3 where the skin portion 15 is not formed constitute two line portions 17 and a display portion 109 which are exposed from the skin portion 15. However, in the present invention, these line portions 17 and display portion 109 are not inevitable, and two line portions 17 and the display portion 109 may be printed on the skin portion 15.

In the present invention, the core material 3 has a shape smaller than a profile of the bowling pin. Although a type of synthetic resin which is a material of the core material 3 is not specifically limited, a polypropylene resin may be named as a preferred raw material of the core material 3. The polypropylene resin is light-weighted, exhibits excellent heat resistance property and excellent injection-moldability, and possesses proper rigidity, proper impact strength and proper hardness and hence, the use of the polypropylene resin is preferable as the material of the core material. Further, the polypropylene resin is preferably used also in view of a low cost and recycling property. It is desirable that an Izod impact strength (with a notch, 20° C., ASTM D253) of the core material 3 is 200 J/m or more and Rockwell R hardness (20° C., ASTM D 785) is 80 or more. Further, in terms of composition, the polypropylene resin is classified into homopolymer, random copolymer which is copolymer, and block copolymer, it is desirable to use block polymer which possesses an excellent impact resistance strength. As a commercially available polypropylene resin, for example, “J-750HP” (product of Idemitsu Kosan Co., Ltd.) is named. Further, it is also possible to impart further excellent properties to the polypropylene resin by mixing other resin into polypropylene resin. For example, it may be possible to use a synthetic resin which is produced by mixing a polyamide resin into the polypropylene resin.

Further, reproduced pellets or the like may be used as a material of the core material 3. The reproduced pellets which have the following composition, for example, can be used.

| | |
|---|---|
| Admer (trademark) | 9 to 15% (percent by weight) |
| 6 nylon (trademark) | 0 to 46% (percent by weight) |
| 666 nylon (trademark) | o to 33% (percent by weight) |
| 12 nylon (trademark) | 0 to 8% (percent by weight) |
| EVOH resin | 0 to 21% (percent by weight) |
| EVAR (trademark) | 0 to 39% (percent by weight) |
| PE (polyethylene) | 0 to 53% (percent by weight) |
| PP (polypropylene) | 0 to 45% (percent by weight) |

These reproduced pellets are adjusted and blended to become 100% in total.

A circumferential groove 4a is formed in an outer surface of a largest diameter portion at a lower portion of the core material 3 such that the circumferential groove 4a circumferentially surrounds the outer surface, and a synthetic resin softer than a synthetic resin which forms the skin portion 15 is fitted into the circumferential groove 4a as a resilient strip 4. By forming the resilient strip 4 softer than the skin portion 15 as a layer below the hard skin portion 15, an impact which is generated when the ball hits the bowling pin is reduced to attenuating a repulsive force of the bowling pin. As a raw material of such a resilient strip 4, any material having resiliency may be used. Here, for example, a material which is made of vinyl chloride, PVC (polyvinyl chloride), TPE (thermoplastic elastomer), silicon rubber, urethane, polypropylene or the like or the mixture thereof maybe preferably used. Among these materials, urethane, polypropylene, or the mixture of urethane and polypropylene may preferably be used. RESAMINE P-4580 produced by Dainichiseika Color & Chemicals Mfg. Co., Ltd. may be used as the urethane. J-750HP produced by Prime Polymer Co., Ltd. may be used as polypropylene. Here, the position at which a recessed portion 4a is formed, that is, that position at which the resilient strip 4 is fitted is set such that a height of the center of the recessed portion 4 or the resilient strip 4 is positioned at a height of the ball. For example, the resilient strip 4 is formed on the largest diameter portion of the bowling pin in a state that the resilient strip 4 having a width of 50 to 60 mm surrounds the bowling pin. Further, a proper thickness of the resilient strip 4 may be a thickness which enables the bowling pin to attenuate the repulsive force of the pin. Here, it is preferable to set the thickness of the resilient strip 4 to 3 to 6 mm.

It is preferable that the skin portion 15 which covers the outer surface of the core material is formed of a hard synthetic resin further having higher friction and wear resistance and higher impact resistance than the resistances which the core material 3 possesses. For example, a polyamide resin having an amide-group bond which is thermoplastic engineering plastic is preferably used. Polyamide resin possesses excellent friction and wear resistance and excellent impact resistance and hence, the polyimide resin is suitable as a material of the skin portion of the bowling pin. As properties of the skin portion, it is desirable that an Izod impact strength (with a notch, 23° C., ASTM D253) is 600 J/m or more and Rockwell R hardness (23° C., ASTM D 785) is 110 or more. The skin portion is required to have higher friction and wear resistances, higher impact resistance and higher hardness than the corresponding properties of the core material 3. This is because that the skin portion is a portion which directly receives an impact from the bowling ball and hence, the skin portion must be completely free from cracks and flaws whereby extremely strict properties are required.

The polyamide resin may be classified into homopolymer (monopolymer) and copolymer nylon which constitutes copolymer depending on the composition thereof. Although both materials can be used as the raw material for the skin portion, a poly ε-caproamide resin ([NH(CH₂)5CO] n, nylon 6) can be preferably used. Further, by blending a trace quantity of the elastomer into the poly ε-caproamide resin, it is possible to impart glossiness and flexibility to the appearance of the skin portion and hence, the poly ε-caproamide resin can be further preferably used as the material of the skin portion. As a commercially available resin which mixes a trace quantity of elastomer into the poly ε-caproamide resin, for example, “Amilan U141” (trade mark) produced by Toray Industries Inc. or the like can be used. Further, by mixing other resin or pigment into the polyamide resin, it is also possible to further impart other properties to the skin portion. For example, it may be also possible to color the skin portion in an ivory system color by mixing pigments into the polyimide resin.

According to the present invention, it is unnecessary to apply a primer or clear painting to the skin portion 15 as an upper layer. The synthetic resin of the above-mentioned skin portion is extremely hard and has the excellent flaw resistance, the excellent friction and wear resistances and the excellent impact resistance or the like and hence, a surface of the skin portion can be kept clean without applying any coating. Marks or patterns may be printed on the surface of the skin portion.

When a display portion 109 is formed on the skin portion 15, the display portion is formed of a curved transparent plate or the like. The transparent plate is formed by being bent in a shape which conforms to the circumference direction of the bowling pin, and a display body to which a character or a pattern is printed is adhered on a back side of the transparent plate using a transparent adhesive agent. As a material of the transparent plate, a transparent resin such as a polycarbonate resin is used.

Here, in the present invention, the molding of the display portion 109 is not inevitable, and a means such as a printing can be also adopted.

Next, a manufacturing method of a bowling pin according to the embodiment 1 is explained. First of all, as a first step, the core material 3 is manufactured preliminarily. That is, as shown in FIG. 3, an upper core 25 and a lower core 23 for forming the upper hollow portion 5a and the lower hollow portion 5b are set on a mold 21 for molding the core material, and a molten synthetic resin is injected into a cavity 27 through gates 26 so as to form the core material 3 by molding. The molded core material 3 includes the upper hollow portion 5a having the upper opening 7 which opens upwardly and the lower hollow portion 5b having the lower opening 11 which opens downwardly.

As shown in FIG. 2, the upper hollow portion 5a and the lower hollow portion 5b are formed on an upper portion and a lower portion of the core material 3, and the upper cap 9 is mounted on the upper hollow portion 5a of the core material 3 and the lower cap 13 is mounted on the lower hollow portion 5b of the core material 3. A semispherical head shape is formed on an upper surface of the upper cap 9. A projecting portion 37 which extends upwardly is formed on a center portion of the head portion of the upper cap 9. The projecting portion 37 constitutes an upper engaging portion for engaging the core material 3 with a mold for forming a skin portion described later.

Next, the lower cap 13 is mounted on the lower hollow portion 5b from the lower opening 11 formed in the core material 3. Further, a lower-portion side wall of the lower cap 13 is inclined so as to form an inclined surface 13b which decreases a diameter thereof in the downward direction. When the lower cap 13 is fitted into the lower hollow portion 5b, the lower-portion side wall of the lower cap 13 becomes coplanar with a lower-end peripheral portion of the core material 3. Here, a cylindrical recessed portion 13a which has a bottom thereof opened is formed in a center portion of a bottom surface of the lower cap 13, and the recessed portion 13a constitutes a lower engaging portion for engaging the core material 3 with a mold for forming a skin portion described later.

Next, as shown in FIG. 4, the core material 3 is fixed to the inside of the mold 22 for forming a resilient strip. By injecting a resin for the resilient strip (a urethane resin, for example) into a gap which is formed between the core material 3 and the mold 22 for forming a resilient strip through the gates 26a, the resilient strip 4 is filled in the circumferential groove 4a which is formed in a state that the circumferential groove 4a surrounds the outer periphery of the largest diameter portion of the core material 3.

Then, as shown in FIG. 5, the core material 3 into which the upper cap 9 and the lower cap 13 are inserted and has the largest diameter portion thereof filled with the resilient strip 4 is fixed to the inside of the cavity 28 which is a space formed between an upper mold 39 and a lower mold 31 which constitute the mold for forming a skin portion. Then, the skin portion 15 is formed by injecting polyamide resin into a gap 28a formed between the core material 3 and the cavity 28 through a gate 51 (see FIG. 1).

To fix the core material 3 to the inside of the cavity 28, the projecting portion 37 of the upper cap 9 is fitted into the recessed portion 37a of the upper mold 39 to form the upper engaging portion, and a pin 31a of the lower mold 31 is fitted into the recessed portion 13a of the lower cap 13 to form the lower engaging portion thus fixing the core material 3 in the inside of the cavity 28 vertically while holding the gap 28a around the core material 3. In this manner, the bowling pin is formed by covering the upper cap 9, the lower cap 13 and the resilient strip 4 with the skin portion 15.

When necessary, a red polyamide resin may be injected into the recessed portion 52 by so-called two-color molding thus forming two line portions 17 (see FIG. 1). However, the line portions 17 can be also formed on the skin portion 15 by printing or the like and hence, the formation of the line portions 17 is not inevitable in the present invention.

In the above-mentioned manner, the core material 3 covered with the skin portion 15 is removed from the upper mold 39 and the lower mold 31, and the projecting portion 37 of the head portion of the upper cap 9 is cut to make the head portion of the upper cap 9 coplanar with an outer surface of the skin portion 15. Here, the upper cap 9, the lower cap 13, the resilient strip 4 and the core material 3 are completely molded (covered) with the skin portion 15 and hence, there is no possibility that the upper cap 9, the lower cap 13 and the resilient strip 4 are removed from the core material 3 during the use of the bowling pin.

### Embodiment 2

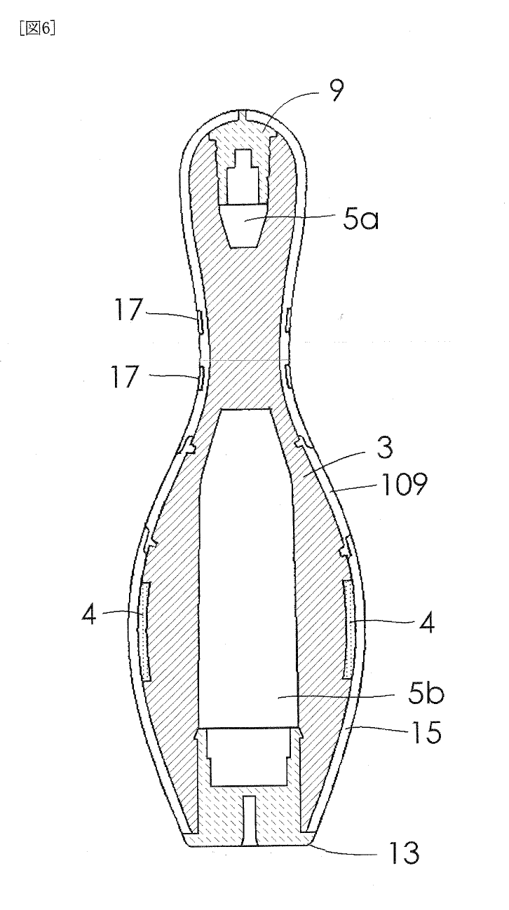

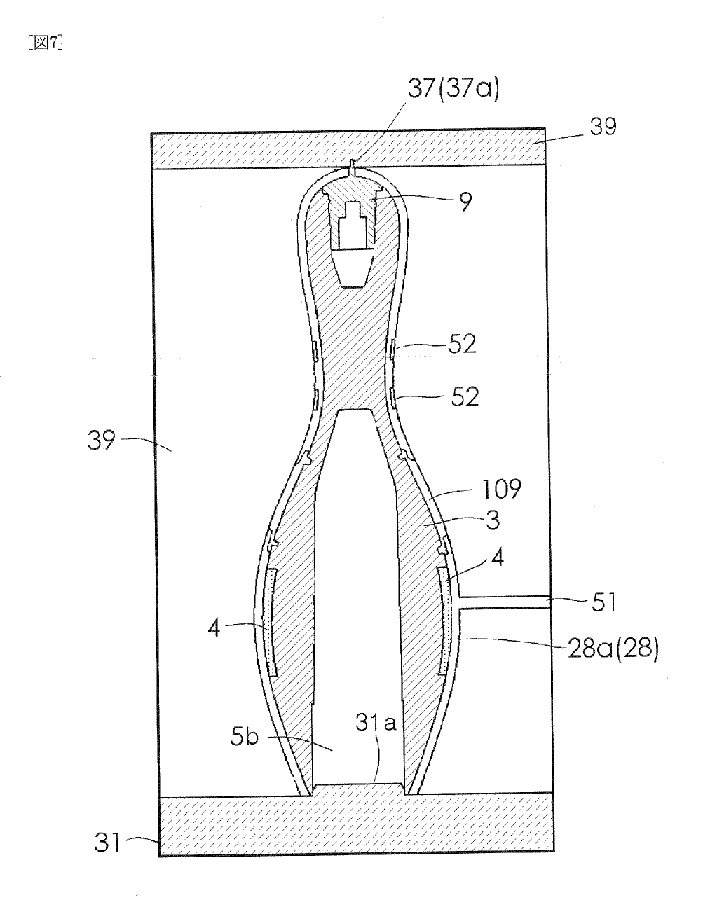

FIG. 6 is a cross-sectional view of a bowling pin of an embodiment 2 in a state that a lower cap is not molded (covered) with a skin portion, and FIG. 7 is a cross-sectional view showing manufacturing steps of the bowling pin of the embodiment 2. The bowling pin according to the embodiment 2 differs from the bowling pin according to the embodiment 1 with respect to a point that the lower cap 13 is not covered with the skin portion 15. The bowling pin according to the embodiment 2 is, as shown in FIG. 7, formed by the following steps. That is, an upper core and a lower core are set on a mold for molding a core material, a molten synthetic resin is injected into a cavity through gates. After the synthetic resin is cooled, the upper core and the lower core are removed thus forming by molding a core material 3 which includes an upper hollow portion 5a having an upper opening which opens upwardly, a lower hollow portion 5b having a lower opening which opens downwardly and a circumferential groove 4a surrounding a largest diameter portion of the core material 3. Then, a synthetic resin softer than the synthetic resin which forms the core material 3 is filled in the circumferential groove 4a so as to form a resilient strip 4 which surrounds the core material 3. Then, as shown in FIG. 6, an upper cap 9 is mounted on the upper hollow portion and, at the same time, a projecting portion 37 of the upper cap 9 is fitted into a recessed portion 37a of an upper mold 38 to form an upper engaging portion, while a pin 31a of a lower mold 31 is fitted into the lower hollow portion to form a lower engaging portion thus fixing the core material 3 to the inside of the cavity 28 vertically while holding a gap 28a around the core material 3. Then, a molten resin is injected into the gap 28a through gates to cover the upper cap 9, the resilient strip 4 and the core material 3 with a skin portion 15. Then, the lower cap 13 is mounted on the lower hollow portion 5b to produce a bowling pin.

Here, by adopting a soft material (such as urethane, mixture of urethane and polypropylene, mixture of urethane and ABS, mixture of urethane and nylon or the like) as a material of the lower cap 13, the bowling pin can obtain an advantageous effect that the bowling pin does not slip sideward when a ball hits the bowling pin.

Further, by applying a pattern to a bottom surface of the lower cap or the like to increase a friction coefficient of the bowling pin, the bowling pin can obtain the same advantageous effect. The lower cap made of such a soft material is applicable to a bowling pin which uses a reinforcing core as described later.

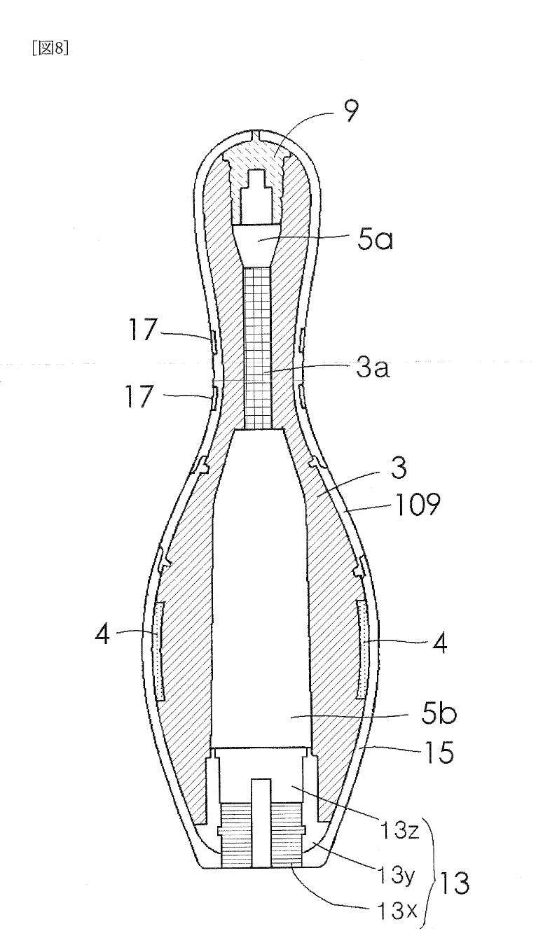

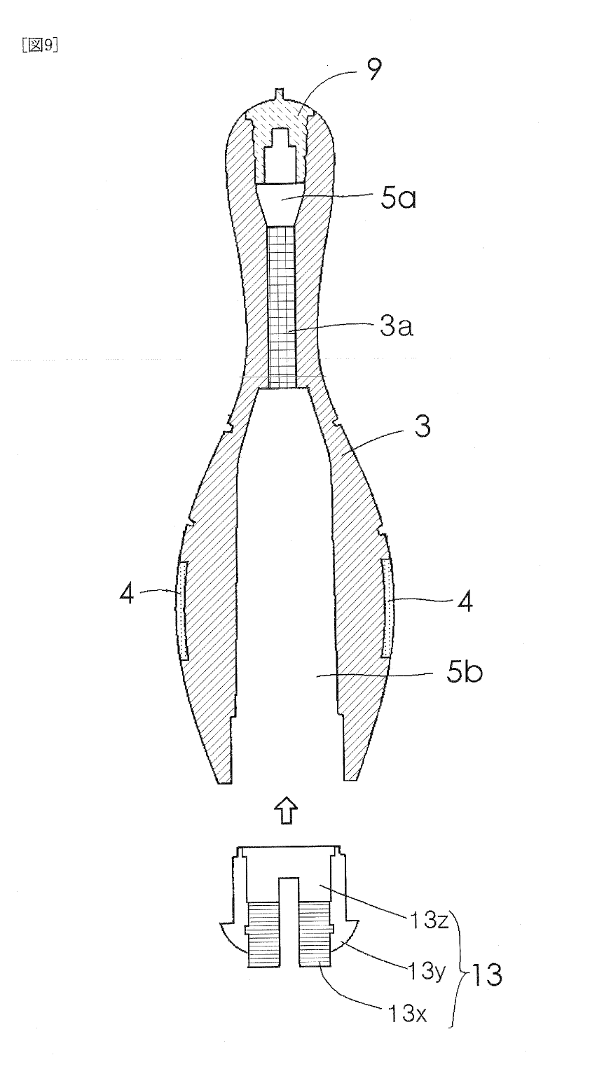

Further, there may also be a case that a portion of the lower cap 13 is molded (covered) with the skin portion. In this case, the bowling pin is covered with the skin portion in a state that, as shown in FIG. 8, a bottom surface of the lower cap 13 is exposed. In such a bowling pin, as shown in FIG. 9, the lower cap 13 is constituted of an exposed member 13x which is made of the above-mentioned soft material (urethane, for example) and is exposed to the bottom surface, a mounting member 13z which is fitted on an upper portion of the exposed member 13x, and a reinforcing member 13y which is integrally formed with the exposed member 13x and the mounting member 13z in a state that the reinforcing member 13y wraps around side surfaces of the exposed member 13x and the mounting member 13z for reinforcing the exposed member 13x and the mounting member 13z. The exposed member 13x, the mounting member 13z and the reinforcing member 13y may be formed of one member without being formed as separate parts. In this case, however, a wall thickness of the lower cap is increased, the deformation of the lower cap attributed to a shrinkage cavity generated in molding is liable to easily occur, a curing time of the resin is prolonged because of the increased wall thickness and hence, the productivity of the lower cap is deteriorated. Accordingly, this embodiment adopts the method which assembles the divided members. Also in this case, the exposed member 13x exposes a soft material on a surface thereof and hence, a slip between the bowling pin and a floor when the bowling pin is set on the floor can be prevented. Further, a lower portion of the lower cap 13 is molded (covered) with the skin portion 15 and hence, there is no possibility that the lower cap 13 is removed from the bowling pin due to an impact or the like when the ball hits the bowling pin.

Here, the bowling pin which exposes the portion of the lower cap 13 is also applicable to a bowling pin which has no resilient strip 4.

### Embodiment 3

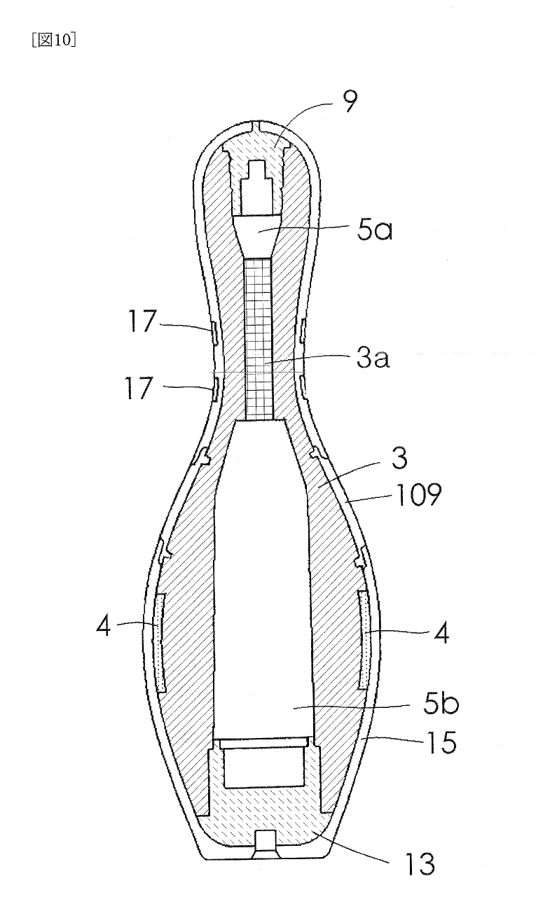

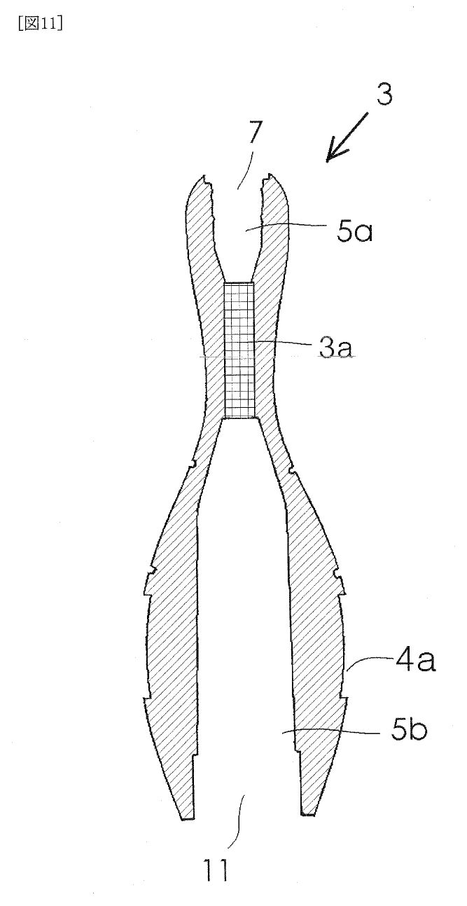

FIG. 10 is a cross-sectional view of a bowling pin according to an embodiment 3 in which a reinforcing core is molded (covered) with a skin portion, and FIG. 11 is a cross-sectional view showing a core material of the bowling pin. The bowling pin according to the embodiment 3 differs from the bowling pin according to the embodiment 1 with respect to a point that the reinforcing core is molded in the core material. The bowling pin according to the embodiment 3 is, as shown in FIG. 10, formed by the following steps. That is, an upper core, a lower core and a reinforcing core 3a which is sandwiched between the upper core and the lower core are set on a mold for molding a core material, a synthetic resin in a molten state is injected into a cavity through gates and is cooled. Thereafter, the upper core and the lower core are removed thus molding the core material 3 which includes an upper hollow portion 5a having an upper opening which opens upwardly, a lower hollow portion 5b having a lower opening which opens downwardly, molds the reinforcing core 3a therein, and includes a circumferential groove 4a surrounding a largest diameter portion of the core material (see FIG. 11). Further, as shown in FIG. 10, a synthetic resin softer than a synthetic resin which constitutes the core material 3 is filled in the circumferential groove 4a thus circumferentially forming a resilient strip 4. An upper cap 9 is mounted on an upper hollow portion 5a and, at the same time, a lower cap 13 is mounted on a lower hollow portion 5b. A projecting portion of the upper cap 9 is fitted into a recessed portion of an upper mold to form an upper engaging portion, while a pin of a lower mold is fitted in a recessed portion of the lower cap 13 to form a lower engaging portion thus fixing the core material 3 to the inside of the cavity vertically while maintaining a gap around the core material 3. Then, a molten resin is injected into the gap through gates to allow the skin portion 15 to cover the upper cap 9, the lower cap 13, the resilient strip 4 and the core material 3 thus producing the bowling pin.

As a shape of the reinforcing core 3a, a rod, a pipe or the like is preferably named. Although, as a transverse cross-sectional shape of the reinforcing core 3a, a round shape, an elliptical shape, a quadrangular shape or the like is named, the shape is not specified particularly. It is preferable that the reinforcing core 3a is formed of a synthetic resin or the like which has an impact resistance or a strength. This is because that the reinforcing core is a member which enhances a strength of the bowling pin when the ball hits the bowling pin or when the bowling pins hit each other and hence, extremely strict properties are required. For example, a polycarbonate resin may be preferably used as a material of the reinforcing core 3a. The polycarbonate resin has the excellent impact resistance and an excellent strength and is preferably used as a reinforcing material for a neck portion of the core material which can resist an impact which the bowling pin receives when the ball hits the bowling pin. Further, the mixture obtained by mixing carbon fibers or glass fibers into resin also contributes to the enhancement of the strength of the core material and hence, the mixture can be preferably applied to the reinforcing core. Furthermore, as the material of the reinforcing core 3a, besides the resin, metal or the like is also applicable to the reinforcing core. As properties of the reinforcing core 3a, it is desirable that an Izod impact strength (with a notch, 23° C., ASTM D253) of the reinforcing core 3a is 700 J/m or more, and the reinforcing core 3a is required to be excellent in both of impact resistance and strength. When a bending test is performed on a bowling pin with the reinforcing core and a bowling pin without the reinforcing core, a following result is obtained. That is, in a state that the bowling pin is laid horizontally and a metal-made base having a size of 28 mm is placed below a lower portion of a head portion of the bowling pin, a neck portion of the bowling pin is pressed downwardly at a speed of 5 mm/min (by using Universal Tester: Autograph AG25TD, product of SHIMADZU CORPORATION). As a result, a largest load is 15.8 kN for the bowling pin with the reinforcing core, and the largest load is 13.1 kN for the bowling pin without the reinforcing core.

### Embodiment 4

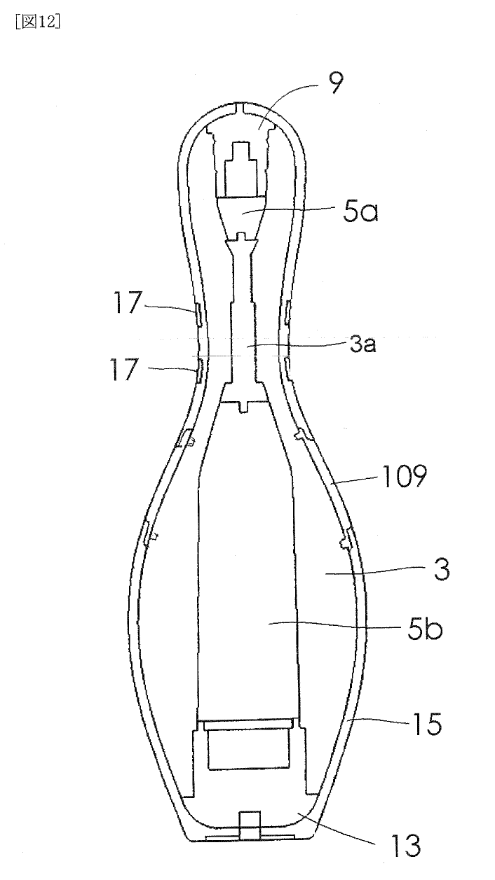

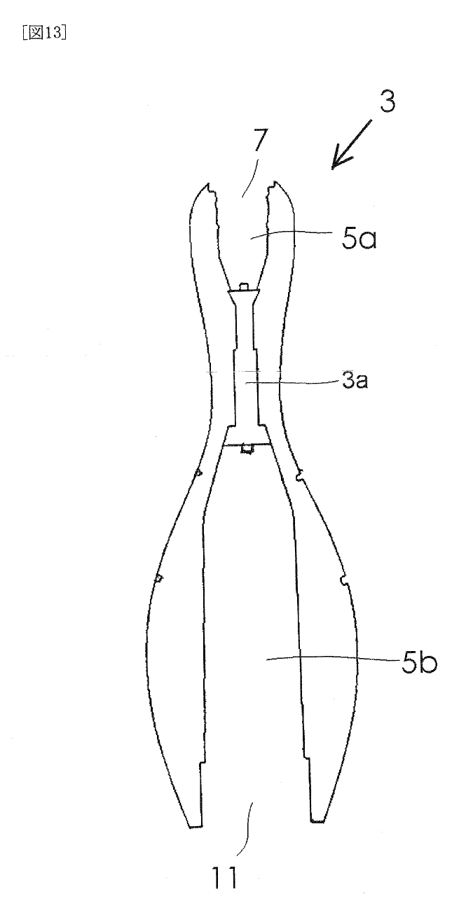

FIG. 12 is a cross-sectional view of a bowling pin according to an embodiment 4, and FIG. 13 is a longitudinal cross-sectional view showing the constitution of a core material which is molded in the inside of a bowling pin according to the embodiment 4. The bowling pin according to the embodiment 4 is as same as the bowling pin according to the embodiment 3 with respect to a point that the bowling pin has a reinforcing core in the inside of the core material. However, this embodiment 4 differs from the embodiment 3 with respect to a point that a resilient strip is not formed in a circumferential groove in a state that the resilient strip surrounds an outer periphery of a largest diameter portion of the core material. In FIG. 12 and FIG. 13, the bowling pin according to the embodiment 4 interposes a reinforcing core 3a thereof between an upper hollow portion 5a and a lower hollow portion 5b.

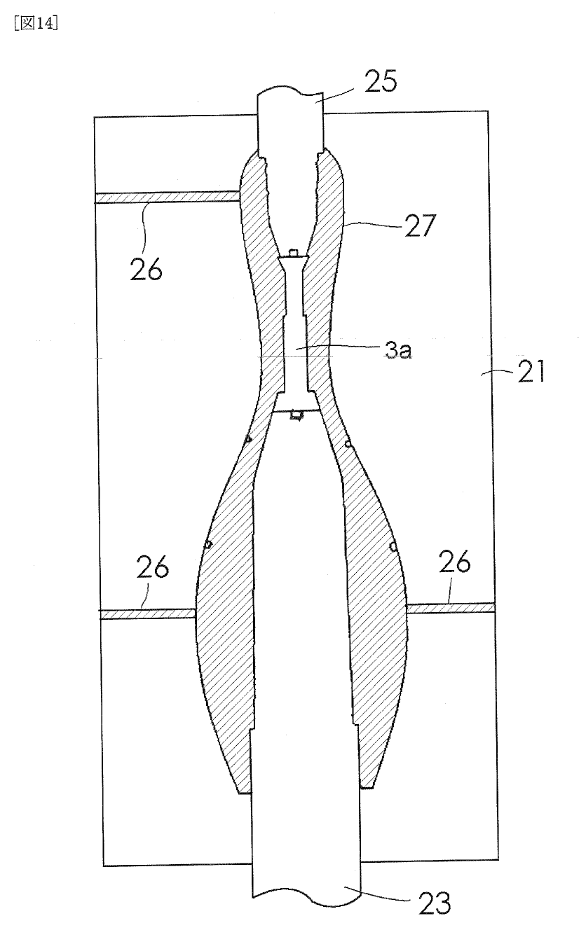

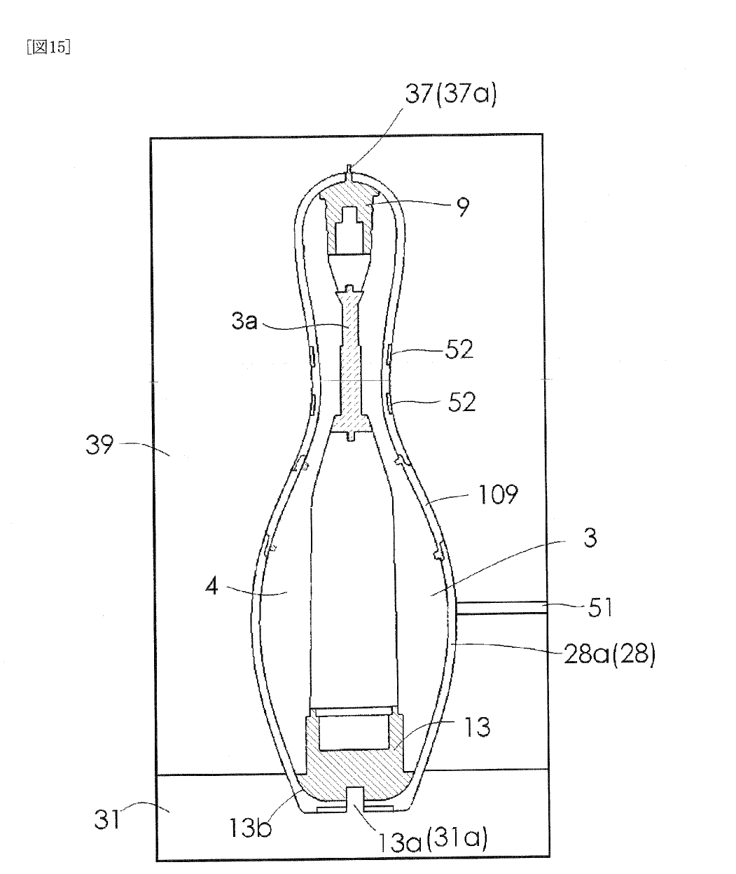

Next, a manufacturing method of a bowling pin according to the embodiment 4 is explained in conjunction with FIG. 14 and FIG. 15. First of all, as a first step, the core material 3 is manufactured preliminarily. That is, as shown in FIG. 14, an upper core 25 and a lower core 23 for forming the upper hollow portion 5a and the lower hollow portion 5b are set on a mold 21 for molding the core material in a state that the upper core 25 and the lower core 23 sandwiches a reinforcing core 3a, and a molten synthetic resin is injected into a cavity 27 through gates 26 so as to form the core material 3 by molding. The molded core material 3 includes the upper hollow portion 5a having the upper opening 7 which opens upwardly and the lower hollow portion 5b having the lower opening 11 which opens downwardly.

As shown in FIG. 13, the upper hollow portion 5a and the lower hollow portion 5b are formed on an upper portion and a lower portion of the core material 3, and, as shown in FIG. 15, the upper cap 9 is mounted on the upper hollow portion 5a of the core material 3 and the lower cap 13 is mounted on the lower hollow portion 5b of the core material 3. A semispherical head portion is formed on an upper surface of the upper cap 9. A projecting portion 37 which extends upwardly is formed on a center portion of the head portion of the upper cap 9. The projecting portion 37 constitutes an upper engaging portion for engaging the core material 3 with a mold for forming a skin portion described later.

Next, the lower cap 13 is mounted on the lower hollow portion 5b from the lower opening 11 formed in the core material 3. Further, a lower-portion side wall of the lower cap 13 is inclined so as to form an inclined surface 13b which decreases a diameter thereof in the downward direction. When the lower cap 13 is fitted into the lower hollow portion 5b, the lower-portion side wall of the lower cap 13 becomes coplanar with a lower-end peripheral portion of the core material 3 with no stepped portion. Here, a cylindrical recessed portion 13a which has a bottom thereof opened is formed in a center portion of a bottom surface of the lower cap 13, and the recessed portion 13a constitutes a lower engaging portion for engaging the core material 3 with a mold for forming a skin portion described later.

Further, bosses of a display portion 109 are respectively fitted into small holes formed in the core material 3 to fix the display portion 109 to the core material 3. Here, in the mold 21 for molding a core material, projecting portions for forming the small holes in an outer peripheral surface of the core material 3 are formed in a state that the projecting portions project into the inside of the cavity 27.

Further, as shown in FIG. 15, the core material 3 on which the upper cap 9, the lower cap 13 and the display plate 109 are mounted is fixed to the inside of a cavity 28 which is a space formed by an upper mold 39 and a lower mold 31 which constitute the mold for forming a skin portion. Then, a polyamide resin is injected into a gap 28a formed between the core material 3 and the cavity 28 through gates 51 to form the skin portion 15 (see FIG. 12).

To fix the core material 3 to the inside of the cavity 28, the projecting portion 37 of the upper cap 9 is fitted into the recessed portion 37a of the upper mold 39 to form the upper engaging portion, and a pin 31a of the lower mold 31 is fitted into the recessed portion 13a of the lower cap 13 to form the lower engaging portion thus fixing the core material 3 in the inside of the cavity 28 vertically while holding the gap 28a around the core material 3. In this manner, the upper cap 9 and the lower cap 13 are completely covered with the skin portion 15 and a recessed portion 52 at which a thickness of the skin portion 15 is small is formed at two upper and lower positions in a squeezed portion or a neck portion (corresponding to an outer peripheral portion of the reinforcing core 3a) of the core material 3.

Next, a red polyamide resin is injected into the recessed portions 52 thus forming two line portions 17 by so-called two-color molding (see FIG. 12). Since the line portions 17 are formed by the synthetic resin filled in the recessed portions 52, there is no possibility that the line portions 17 disappear by wear different from line portions which are formed by coating. Here, the number of line portions is not limited to two and may be one, three or the line portions may be replaced with a figure. For example, a design such as a bottle cap of Brunswick Bowling and Billiards Corp. may be formed by injecting a synthetic resin into the above-mentioned recessed portions 52 as a pattern portion 17.

When the skin portion 15 is formed, the display portion 109 is exposed (forming an exposed portion which exposes a display body from the skin portion). As described above, the core material 3 which is covered with the skin portion 15, the line portions 17 and the like is removed from the upper mold 39 and the lower mold 31, the projecting portion 37 formed on the head portion of the upper cap 9 is cut to make the head portion of the upper cap 9 coplanar with an outer surface of the skin portion 15. Here, the upper cap 9 and the lower cap 13 are completely molded by the skin portion 15 which covers the upper cap 9 and the lower cap 13 integrally with the core material 3 and hence, there is no possibility that the upper cap 9 and the lower cap 13 are removed during the use of the bowling pin.

Although the embodiments of the present invention are explained in detail heretofore, the specific constitution of the present invention is not limited to such embodiments, and the present invention includes various design modifications without departing from the gist of the present invention. For example, although the line portions are formed in the recessed portions 52 in the embodiments, by preparing a mold having a shape of a recessed portion, designs of various patterns may be formed.

In the drawing, the explanation of symbols is as follows. 1: bowling pin, 3: core material, 3a: reinforcing core, 4: resilient strip, 4a: circumference groove, 5a: upper hollow portion, 5b: lower hollow portion, 7: upper opening, 9: upper cap, 11: lower opening, 13: lower cap, 13a: recessed portion, 13b: inclined surface, 13x: exposed member, 13y: reinforcing member, 13z: mounting member, 15: skin portion, 17: line portion (pattern portion), 21: mold for forming core material, 23: lower core, 25: upper core, 26, 26a: gate, 27: cavity, 28: cavity, 28a: gap, 31: lower mold, 31a: pin, 37: projecting portion, 37a: recessed portion, 39: upper mold, 51: gate, 52: recessed portion, 109: display portion

### INDUSTRIAL APPLICABILITY

As has been explained heretofore, the bowling pin of the present invention forms the resilient strip having resiliency at the position where the ball hits the bowling pin in a molded state and hence, the bowling pin can not only attenuate the pin action of the bowling pin when the bowling pin receives the strong impact of the ball but also can prevent the separation of the resilient strip from the bowling pin when the bowling pin is used in a bowling game thus possessing the extremely high industrial applicability.

### BRIEF DESCRIPTION OF THE DRAWINGS

[FIG. 1]

A longitudinal cross-sectional view showing the constitution of a bowling pin of an embodiment 1 according to the present invention.

[FIG. 2]

A longitudinal cross-sectional view showing the constitution of a core material which is molded in the inside of the bowling pin of the embodiment 1.

[FIG. 3]

A longitudinal cross-sectional view for explaining a manufacturing method of the core material of the embodiment 1.

[FIG. 4]

A longitudinal cross-sectional view for explaining a method for forming a resilient strip in a circumferential groove such that the circumferential groove surrounds a largest outer diameter portion of the core material of the embodiment 1.

[FIG. 5]

A longitudinal cross-sectional view for explaining a method for forming a skin portion on a surface of the core material of the embodiment 1.

[FIG. 6]

A cross-sectional view of the bowling pin of an embodiment 2 showing a case in which a lower cap is not covered with the skin portion by molding (by covering).

[FIG. 7]

A cross-sectional view showing a manufacturing step of the bowling pin of the embodiment 2.

[FIG. 8]

An explanatory view of the bowling pin covered with the skin portion in a state that a bottom surface of the lower cap is exposed on a surface of the bowling pin.

[FIG. 9]

An explanatory view showing a state that members which constitute the lower cap 13 are assembled.

[FIG. 10]

A cross-sectional view of the bowling pin according to an embodiment 3 in which a reinforcing core is molded (covered).

[FIG. 11]

A cross-sectional view showing a core material of the bowling pin according to the embodiment 3.

[FIG. 12]

A longitudinal cross-sectional view showing the constitution of the bowling pin of an embodiment 4.

[FIG. 13]

A longitudinal cross-sectional view showing the constitution of the core material which is molded in the inside of the bowling pin of the embodiment 4.

[FIG. 14]

An explanatory view of a manufacturing method of the bowling pin of the embodiment 4.

[FIG. 15]

An explanatory view of a manufacturing method of the bowling pin of the embodiment 4.

1. A manufacturing method of a bowling pin comprising:
a core material manufacturing step for forming a core material having a shape smaller than a profile of the bowling pin by molding; and
a skin portion forming step for covering an outer surface of the core material, wherein
an upper core, a lower core and a reinforcing core which is sandwiched between the upper core and the lower core are set in a core material forming mold,
a synthetic resin in a molten state is injected into a cavity through a gate and is cooled and, thereafter,
the upper core and the lower core are removed thus forming by molding the core material which includes an upper hollow portion having an upper opening which opens upwardly and a lower hollow portion having a lower opening which opens downwardly, and molds the reinforcing core therein,
an upper cap is mounted on the upper hollow portion and a lower cap is mounted on the lower hollow portion,
a projecting portion of the upper cap is inserted into a recessed portion of an upper mold thus forming an upper engaging portion, a pin of a lower mold is inserted into a recessed portion of the lower cap thus forming a lower engaging portion,
the core material is vertically fixed to the inside of the cavity while maintaining a gap around the core material, and a molten resin is injected into the gap through a gate thus forming the skin portion and integrally covering the upper cap, the lower cap and the core material with the skin portion.

2. A bowling pin comprising:
a core material having a shape smaller than a profile of the bowling pin; and
a skin portion covering an outer surface of the core material, wherein
the core material is formed of an upper hollow portion having an upper opening which opens upwardly, a lower hollow portion having a lower opening which opens downwardly, and a reinforcing core which is formed by molding between the upper hollow portion and the lower hollow portion,
an upper cap is mounted on the upper hollow portion and a lower cap is mounted on the lower hollow portion, and
the upper cap, the lower cap and the core material are integrally formed in a state that the upper cap, the lower cap and the core material are covered with the skin portion.

3. A bowling pin according to claim 2, wherein the lower cap is formed and covered with the skin portion in a state that a bottom surface of the lower cap is exposed to a surface of the bowling pin.

4. A manufacturing method of a bowling pin comprising:
a core material manufacturing step for forming a core material having a shape smaller than a profile of the bowling pin by molding; and
a skin portion forming step for covering an outer surface of the core material, wherein
an upper core and a lower core are set in a core material forming mold,
a synthetic resin in a molten state is injected into a cavity through a gate and is cooled and, thereafter,
the upper core and the lower core are removed thus forming by molding the core material which includes an upper hollow portion having an upper opening which opens upwardly, a lower hollow portion having a lower opening which opens downwardly and a circumferential groove which surrounds a largest diameter portion of the core material and, thereafter,
a resilient strip is circumferentially formed by filling a synthetic resin softer than a synthetic resin for forming the core material into the circumferential groove,
an upper cap is mounted on the upper hollow portion and a lower cap is mounted on the lower hollow portion,
a projecting portion of the upper cap is inserted into a recessed portion of an upper mold thus forming an upper engaging portion, a pin of a lower mold is inserted into a recessed portion of the lower cap thus forming a lower engaging portion,
the core material is vertically fixed to the inside of the cavity while maintaining a gap around the core material, and
a molten resin is injected into the gap through a gate thus covering the upper cap, the lower cap, the resilient strip and the core material with the skin portion.

5. A manufacturing method of a bowling pin comprising:
a core material manufacturing step for forming a core material having a shape smaller than a profile of the bowling pin by molding; and
a skin portion forming step for covering an outer surface of the core material, wherein
an upper core and a lower core are set in a core material forming mold,
a synthetic resin in a molten state is injected into a cavity through a gate and is cooled and, thereafter,
the upper core and the lower core are removed thus forming by molding the core material which includes an upper hollow portion having an upper opening which opens upwardly, a lower hollow portion having a lower opening which opens downwardly and a circumferential groove which surrounds a largest diameter portion of the core material and, thereafter,
a resilient strip is circumferentially formed by filling a synthetic resin softer than a synthetic resin for forming the core material into the circumferential groove,
an upper cap is mounted on the upper hollow portion and a projecting portion of the upper cap is fitted in a recessed portion of an upper mold thus forming an upper engaging portion,
a pin of a lower mold is fitted in the lower hollow portion thus forming a lower engaging portion,
the core material is vertically fixed to the inside of the cavity while maintaining a gap around the core material, and
a molten resin is injected into the gap through a gate thus covering the upper cap, the resilient strip and the core material with the skin portion and, thereafter, a lower cap is mounted on the lower hollow portion.

6. A manufacturing method of a bowling pin comprising:
a core material manufacturing step for forming a core material having a shape smaller than a profile of the bowling pin by molding; and
a skin portion forming step for covering an outer surface of the core material, wherein
an upper core, a lower core and a reinforcing core which is sandwiched between the upper core and the lower core are set in a core material forming mold,
a synthetic resin in a molten state is injected into a cavity through a gate and is cooled and, thereafter,
the upper core and the lower core are removed thus forming by molding the core material which includes an upper hollow portion having an upper opening which opens upwardly and a lower hollow portion having a lower opening which opens downwardly, molds the reinforcing core therein, and includes a circumferential groove which surrounds a largest diameter portion of the core material and, thereafter,
a resilient strip is circumferentially formed by filling a synthetic resin softer than a synthetic resin for forming the core material into the circumferential groove,
an upper cap is mounted on the upper hollow portion and a lower cap is mounted on the lower hollow portion,
a projecting portion of the upper cap is inserted into a recessed portion of an upper mold thus forming an upper engaging portion, a pin of a lower mold is inserted into a recessed portion of the lower cap thus forming a lower engaging portion,
the core material is vertically fixed to the inside of the cavity while maintaining a gap around the core material, and a molten resin is injected into the gap through a gate thus covering the upper cap, the lower cap, the resilient strip and the core material with the skin portion.

7. A manufacturing method of a bowling pin comprising:
a core material manufacturing step for forming a core material having a shape smaller than a profile of the bowling pin by molding; and
a skin portion forming step for covering an outer surface of the core material, wherein
an upper core, a lower core and a reinforcing core which is sandwiched between the upper core and the lower core are set in a core material forming mold,
a synthetic resin in a molten state is injected into a cavity through a gate and is cooled and, thereafter,
the upper core and the lower core are removed thus forming by molding the core material which includes an upper hollow portion having an upper opening which opens upwardly and a lower hollow portion having a lower opening which opens downwardly, molds the reinforcing core therein, and includes a circumferential groove which surrounds a largest diameter portion of the core material and, thereafter,
a resilient strip is circumferentially formed by filling a synthetic resin softer than a synthetic resin for forming the core material into the circumferential groove,
an upper cap is mounted on the upper hollow portion and a projecting portion of the upper cap is fitted into a recessed portion of an upper mold thus forming an upper engaging portion, and a pin of a lower mold is fitted into the lower hollow portion thus forming a lower engaging portion,
the core material is vertically fixed to the inside of the cavity while maintaining a gap around the core material, and
a molten resin is injected into the gap through a gate thus covering the upper cap, the resilient strip and the core material with the skin portion and, thereafter, a lower cap is mounted on the lower hollow portion.

8. A bowling pin comprising:
a core material having a shape smaller than a profile of the bowling pin; and
a skin portion covering an outer surface of the core material, wherein
the core material is formed of an upper hollow portion having an upper opening which opens upwardly, a lower hollow portion having a lower opening which opens downwardly, and a circumferential groove which surrounds a largest diameter portion of the core material,
an upper cap is mounted on the upper hollow portion and a lower cap is mounted on the lower hollow portion,
a resilient strip made of a synthetic resin softer than a synthetic resin for forming the core material is circumferentially formed in the circumferential groove, and
the upper cap, the lower cap, the resilient strip and the core material are covered with the skin portion.

9. A bowling pin comprising:
a core material having a shape smaller than a profile of the bowling pin; and
a skin portion covering an outer surface of the core material, wherein
the core material is formed of an upper hollow portion having an upper opening which opens upwardly, a lower hollow portion having a lower opening which opens downwardly, and a circumferential groove which surrounds a largest diameter portion of the core material,
an upper cap is mounted on the upper hollow portion and a lower cap is mounted on the lower hollow portion,
a resilient strip made of a synthetic resin softer than a synthetic resin for forming the core material is circumferentially formed in the circumferential groove, and
the upper cap, the resilient strip and the core material are covered with the skin portion.

10. A bowling pin according to claim 8, wherein a reinforcing core is molded in the core material.

11. A bowling pin according to claim 9, wherein a reinforcing core is molded in the core material.
